(19) United States
(12) Patent Application Publication
(10) Pub. No.: US 2024/0205532 A1
(43) Pub. Date: Jun. 20, 2024

(54) IMAGE CAPTURING APPARATUS, CONTROL METHOD THEREOF, AND STORAGE MEDIUM

(71) Applicant: CANON KABUSHIKI KAISHA, Tokyo (JP)

(72) Inventor: Shunsuke NINOMIYA, Kanagawa (JP)

(21) Appl. No.: 18/539,543

(22) Filed: Dec. 14, 2023

(30) Foreign Application Priority Data
Dec. 20, 2022 (JP) 2022-203529

(51) Int. Cl. H04N 23/611; G06T 7/70; G06V 10/74; H04N 23/695

(52) U.S. Cl. CPC H04N 23/611; G06T 7/70; G06V 10/761; H04N 23/695; G06T 2207/20132

(57) ABSTRACT

An image capturing apparatus includes an image capturing device, a first obtainment unit that, using a first method, obtains first information that is information pertaining to a position of the subject; a second obtainment unit that, using a second method, obtains second information that is information pertaining to the position of the subject; and a changing unit that changes an angle of view of the image capturing device. The changing unit performs at least one of changing the angle of view in a first direction or changing a magnitude of the angle of view, based on the first information, and performs at least one of changing the angle of view in a second direction different from the first direction or changing a magnitude of the angle of view, based on the second information.

### BACKGROUND OF THE INVENTION

### Field of the Invention

The present invention relates to an image capturing apparatus.

### Description of the Related Art

In recent years, in image capturing apparatuses such as cameras and smartphones, as well as devices such as platforms and gimbals on which such apparatuses are mounted, techniques which assist in shooting images, such as tracking subjects and adjusting focus by detecting a subject based on shot image information, have become common. However, in methods which detect a subject based on image information, if, for example, a main subject on the screen is hidden behind an object other than the main subject, the main subject cannot be detected.

Accordingly, a technique that enables a camera to recognize the position of a subject by attaching an apparatus that transmits position information to the subject has been proposed.

Japanese Patent Laid-Open No. 2006-270274 discloses a technique in which a subject detection range is determined on a screen based on position information from an apparatus attached to a subject, and the subject is then detected.

However, with the conventional technique disclosed in Japanese Patent Laid-Open No. 2006-270274, the subjects that can be detected are limited to subjects within the angle of view of the image capturing apparatus.

### SUMMARY OF THE INVENTION

Having been achieved in light of the aforementioned issue, the present invention provides an image capturing apparatus capable of tracking and shooting a subject while accurately detecting the subject.

According to a first aspect of the present invention, there is provided an image capturing apparatus comprising: an image capturing device that captures an image of a subject; and at least one processor or circuit configured to function as: a first obtainment unit that, using a first method, obtains first information that is information pertaining to a position of the subject; a second obtainment unit that, using a second method different from the first method, obtains second information that is information pertaining to the position of the subject; and a changing unit that changes an angle of view of the image capturing device, wherein the changing unit performs at least one of changing the angle of view in a first direction or changing a magnitude of the angle of view, based on the first information, and performs at least one of changing the angle of view in a second direction different from the first direction or changing a magnitude of the angle of view, based on the second information.

According to a second aspect of the present invention, there is provided a method of controlling an image capturing apparatus, the image capturing apparatus including an image capturing device that captures an image of a subject, and the method comprising: obtaining, using a first method, first information that is information pertaining to a position of the subject; obtaining, using a second method different from the first method, second information that is information pertaining to the position of the subject; and changing an angle of view of the image capturing device, wherein the changing includes performing at least one of changing the angle of view in a first direction or changing a magnitude of the angle of view, based on the first information, and performing at least one of changing the angle of view in a second direction different from the first direction or changing a magnitude of the angle of view, based on the second information.

Further features of the present invention will become apparent from the following description of exemplary embodiments with reference to the attached drawings.

### BRIEF DESCRIPTION OF THE DRAWINGS

FIG. 1 is a block diagram illustrating the configuration of an image capturing apparatus according to a first embodiment of the present invention.

FIG. 2 is a diagram illustrating an extracted view of a measurement unit and a first information obtainment unit.

FIG. 3 is a diagram illustrating an image obtained by the image capturing apparatus and information obtained by a second information obtainment unit.

FIGS. 4A to 4C are diagrams illustrating the configuration of an angle of view changing unit according to the first embodiment.

FIGS. 5A to 5C are diagrams illustrating changes in an angle of view in the horizontal direction according to the first embodiment.

FIGS. 6A and 6B are diagrams illustrating changes in an angle of view when a subject is located outside the angle of view, according to the first embodiment.

FIGS. 7A to 7C are diagrams illustrating changes in an angle of view in the vertical direction according to the first embodiment.

FIGS. 8A to 8C are diagrams illustrating changes in the size of an angle of view according to the first embodiment.

FIGS. 9A and 9B are diagrams illustrating changes in the angle of view during tilting relative to the vertical direction, according to the first embodiment.

FIGS. 10A and 10B are diagrams illustrating the configuration of an image capturing apparatus according to a second embodiment.

FIGS. 11A to 11D are diagrams illustrating changes in an angle of view according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

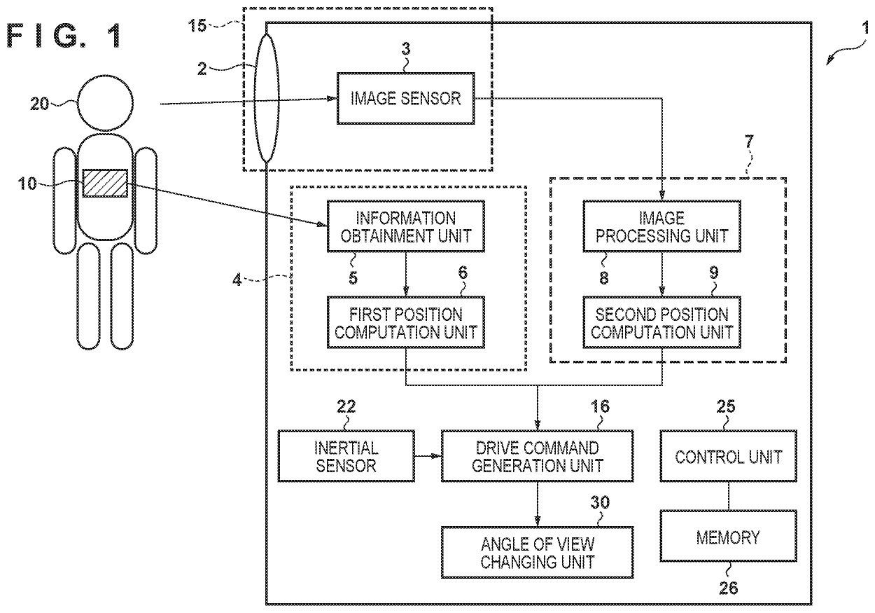

FIG. 1 is a block diagram illustrating the overall configuration of an image capturing apparatus 1 according to a first embodiment of the present invention.

The image capturing apparatus 1 includes a camera unit 15, a first information obtainment unit 4, a second information obtainment unit 7, an angle of view changing unit 30, a control unit 25, and a memory 26. The camera unit 15 includes a lens 2 and an image sensor 3. The first information obtainment unit 4 includes an information obtainment unit 5 and a first position computation unit 6. The second information obtainment unit 7 includes an image processing unit 8 and a second position computation unit 9. The control unit 25, which is constituted by a microcomputer or the like, controls the image capturing apparatus 1 as a whole by executing programs stored in the memory 26.

A CMOS image sensor or the like is used as the image sensor 3, which photoelectrically converts light passing through the lens 2. A signal generated by the image sensor 3 undergoes various types of image processing in the image processing unit 8. The various types of image processing include preprocessing such as signal amplification, reference level adjustment, and the like; color interpolation processing for interpolating the values of color components not included in the image data; correction processing for white balance adjustment and correcting image brightness; detection processing; and the like. The processed image data is recorded by the image processing unit 8. Note that the detection processing includes processing for detecting and tracking a characteristic region (e.g., a face region or a human body region), processing for recognizing a person or an animal, and the like.

The information obtainment unit 5 of the first information obtainment unit 4 obtains information on a subject 20 transmitted by a measurement unit 10 attached to the subject 20. The first position computation unit 6 calculates the position of the subject 20 relative to the image capturing apparatus 1, the distance from the image capturing apparatus 1 to the subject 20, and the like based on data obtained by the information obtainment unit 5.

Here, the measurement unit 10 can measure a position on Earth using a Global Positioning System (GPS). Alternatively, the relative positions of the measurement unit 10 and the image capturing apparatus 1 can be measured using one or more transmitters and receivers provided in the measurement unit 10 and the image capturing apparatus 1, respectively. However, the method for detecting the relative positions of the measurement unit 10 and the image capturing apparatus 1 is not limited to these methods. Note that the present embodiment will describe position measurement using GPS as an example.

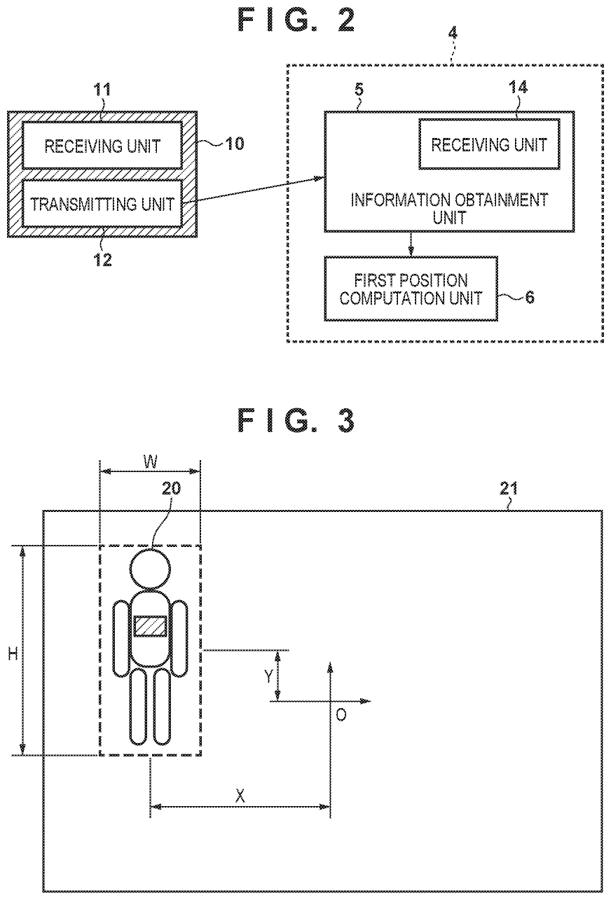

FIG. 2 is a diagram illustrating an extracted view of the measurement unit 10 and the first information obtainment unit 4. As illustrated in FIG. 2, the measurement unit 10 includes a receiving unit 11 and a transmitting unit 12. The receiving unit 11 receives signals from a plurality of artificial satellites (not shown), and detects the position of the measurement unit 10 based on the received signals. The detected position information is recognized as three-dimensional data based on a coordinate system fixed to a macroscopically immobile object, such as the Earth. For example, by taking the center of the Earth as an origin, three axes, that is, the axis of rotation of the Earth, an axis passing through the origin and a predetermined point on the equator, and an axis orthogonal to the axis through the origin can be used to specify an arbitrary position. The transmitting unit 12 transmits (communicates) the information of the specified position to the information obtainment unit 5 of the image capturing apparatus 1.

Likewise, the information obtainment unit 5 of the image capturing apparatus 1 is also provided with a receiving unit 14, which receives signals from a plurality of artificial satellites and detects the position of the image capturing apparatus 1 based on the received signals. The first position computation unit 6 calculates the position of the measurement unit 10 relative to the image capturing apparatus 1, the distance from the image capturing apparatus 1 to the measurement unit 10, and the like based on position information of the measurement unit 10 and the image capturing apparatus 1 obtained by the information obtainment unit 5. Through this, the position information of the subject 20 and the distance information from the image capturing apparatus 1 to the subject 20 can be obtained. In other words, the first information obtainment unit 4 can obtain position information, distance information, and the like of the subject 20 from the measurement unit 10 attached to the subject 20. Note that the position information, distance information, and the like obtained by the first information obtainment unit 4 will be referred to as “first information” in the present embodiment.

FIG. 3 is a diagram illustrating an example in which the subject 20 is present in an image 21 obtained by the image sensor 3. The second position computation unit 9 calculates the position/size of the subject 20 in the image 21 based on the image data processed by the image processing unit 8. For example, as illustrated in FIG. 3, positions (X, Y) from a center O of the image 21 to the center of the subject 20, a height (H) of the subject 20, and a width (W) of the subject 20 are calculated. In other words, the second information obtainment unit 7 can obtain information such as the position, size, and the like of the subject 20 from the image 21. Note that the position information, size information, and the like of the subject 20 obtained by the second information obtainment unit 7 will be referred to as “second information” in the present embodiment.

As described above, the image capturing apparatus 1 can obtain the three-dimensional position of the subject 20 relative to the image capturing apparatus 1 using the first information obtainment unit 4, and obtain the position/size of the subject 20 in the image 21 using the second information obtainment unit 7.

Note that the image capturing apparatus 1 includes an inertial sensor 22 capable of detecting tilt, angle changes, and the like of the image capturing apparatus 1 as attitude information. The image capturing apparatus 1 obtains information pertaining to the position, distance, size, and the like of the subject 20 using the first information obtainment unit 4 and the second information obtainment unit 7, and obtains the attitude information using the inertial sensor 22. Based on this information, a drive command generation unit 16 generates drive commands for the angle of view changing unit 30 and the lens 2. The generated drive commands are transmitted to the angle of view changing unit 30 and the lens 2, and by performing drive control in the pan/tilt/roll directions, zoom operations by the lens 2, and the like, the angle of view of the camera unit 15 can be changed and the subject 20 can be tracked automatically. As a result, an image in which the subject 20 falls within the angle of view can be shot by the camera unit 15 without requiring user operations.

Note that in the present embodiment, the respective coordinate axes are defined as follows. The direction indicated by the optical axis of an optical system constituted by the lens 2 and the image sensor 3 is an optical axis direction (a Z direction); a direction orthogonal to the optical axis direction and parallel to the direction of gravity is a vertical direction (a Y direction); and a direction orthogonal to both the optical axis direction and the direction of gravity is a horizontal direction (an X direction).

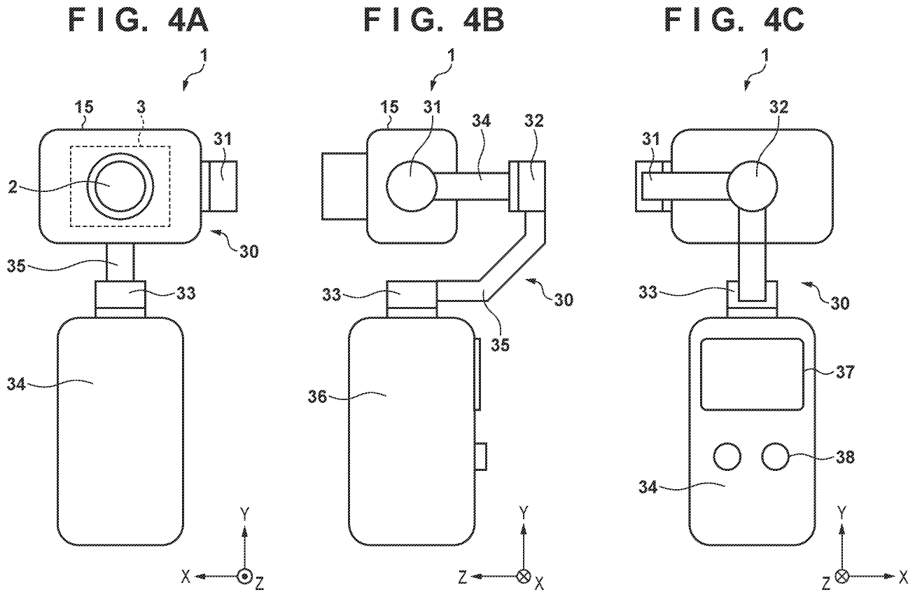

The angle of view changing unit 30 according to the present embodiment will be described next with reference to FIGS. 4A to 4C. The image capturing apparatus 1 includes the camera unit 15, which has the lens 2 and the image sensor 3, as well as the angle of view changing unit 30, which changes the angle of view of the camera unit 15 by rotationally driving the camera unit 15. Note that the camera unit 15 is image obtainment means.

The angle of view changing unit 30 is configured including a tilt drive part 31, a roll drive part 32, a pan drive part 33, a first arm part 34, a second arm part 35, and a grip part 36. The tilt drive part 31 is provided between the camera unit 15 and the first arm part 34, the roll drive part 32 is provided between the first arm part 34 and the second arm part 35, and the pan drive part 33 is provided between the second arm part 35 and the grip part 36.

By rotating each of the drive parts, the two members connected by those drive parts can be rotated relative to each other. When the pan drive part 33 rotates, the area from the second arm part 35 to the camera unit 15 rotates, and the angle of view of the camera unit 15 changes in the horizontal direction (the X direction). When the roll drive part 32 rotates, the area from the tilt drive part 31 to the camera unit 15 rotates, and the angle of view of the camera unit 15 rotates about the optical axis (a Z axis). When the tilt drive part 31 rotates, the camera unit 15 rotates, and the angle of view of the camera unit 15 changes in the vertical direction (the Y direction).

Although the changing of the angle of view by the angle of view changing unit 30 has been described thus far using a state in which the grip part 36 is vertical and the camera unit 15 has no tilt as an example, the angle of view is changed in a predetermined direction by changing the drive parts, driving a plurality of drive parts, and so on in accordance with the attitude of the image capturing apparatus 1. By rotationally driving the three drive parts, the camera unit 15 can rotate about the three axes, relative to the grip part 36. As a result, when the grip part 36 that the photographer grips is shaken or the like, the camera unit 15 can obtain a stable image that is not blurry by driving the movable parts so as to cancel out the shaking. It is also possible to shoot while changing the angle of view of the camera unit 15 in any desired manner by driving each drive part in accordance with operations by the photographer or a predetermined sequence. The grip part 36 is provided with a screen 37 for displaying the image 21 obtained by the image sensor 3, various types of information, settings screens, and the like, and an operation unit 38 for inputting operations made by the photographer.

An image shooting sequence according to the present embodiment will be described next. In the present embodiment, the information on the subject 20 (the position, distance, size, and the like) is obtained by the aforementioned first information obtainment unit 4 and second information obtainment unit 7, and the angle of view of the image obtained by the image sensor 3 is changed by the angle of view changing unit 30 driving the camera unit 15 based on this information. Specifically, the position, size, and the like of the subject 20 in the image 21 from the image sensor 3 change as the subject 20 moves, and this is detected by either or both of the first information obtainment unit 4 and the second information obtainment unit 7. The angle of view of the camera unit 15 is then changed by the angle of view changing unit 30 such that the subject 20 is located at the proximate center of the image 21 at a predetermined size. Through this, the subject 20 can be automatically tracked and continuously kept at the predetermined size in the proximate center of the image 21, even when the subject 20 moves. This shooting method will be called “subject tracking shooting” in the present embodiment.

Although the present embodiment has described an example in which the subject 20 is continuously kept in the proximate center of the image 21 as an example, the subject tracking shooting may be performed such that the subject 20 is continuously kept at a desired position specified by the photographer within the angle of view of the camera unit 15, for example. Additionally, the size of the subject 20 may also be changed as appropriate through operations performed by the photographer.

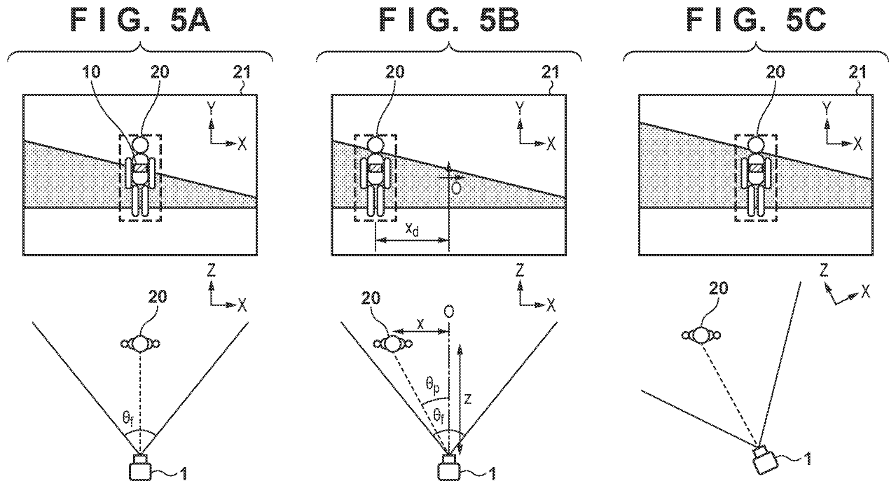

First, subject tracking shooting performed when the subject 20 has moved in the horizontal direction will be described with reference to FIGS. 5A to 5C. In FIGS. 5A to 5C, the diagrams on top are diagrams illustrating the image 21 obtained by the image sensor 3, and the diagrams on the bottom are diagrams illustrating the image capturing apparatus 1 and the subject 20 viewed from the vertical direction (the Y direction).

At the point in time of FIG. 5A, the subject 20 is located at the proximate center of the image 21. In contrast, in FIG. 5B, the subject 20 has moved by x in the horizontal direction (the X direction), and the subject 20 is located at a position shifted from the center of the image 21 by an amount xd. The relative positional relationship between the image capturing apparatus 1 and the subject 20 at this time can be obtained by the first information obtainment unit 4. From a position z of the subject 20 in the optical axis direction and the position x in the horizontal direction, an angle θp of the subject 20 relative to the direction of an optical axis O of the camera unit 15 can be calculated through the following formula.

$$θ p = {tan}^{- 1} ( x / z ) \qquad ( 1 )$$

The image capturing apparatus 1 drives the pan drive part 33 of the angle of view changing unit 30 and rotates the camera unit 15 in the horizontal direction based on the drive commands generated by the drive command generation unit 16 such that the angle θp calculated as indicated above becomes 0. As a result, the angle of view can be changed such that the subject 20 is located at the proximate center of the image 21, as illustrated in FIG. 5C. Repeating the above-described processing makes it possible for the image capturing apparatus 1 to continuously keep the subject 20 in the proximate center of the image 21 even when the subject 20 moves in the horizontal direction.

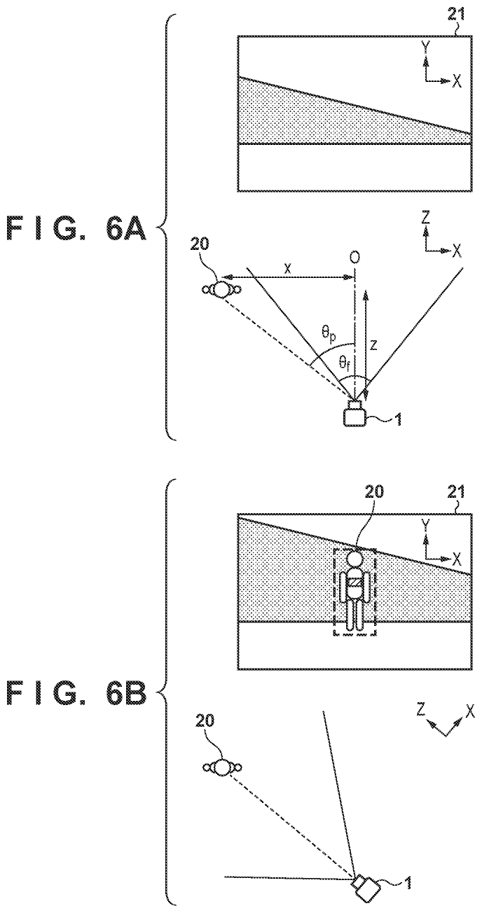

FIGS. 6A and 6B are diagrams illustrating subject tracking shooting in the horizontal direction, performed when the subject 20 is located outside the angle of view of the camera unit 15.

The image capturing apparatus 1 can calculate a shooting angle of view θf, which indicates a range to appear in the image 21 obtained by the image sensor 3, using information on the lens 2, the image sensor 3, and the like. When the angle θp indicating the direction of the subject 20 exceeds half the shooting angle of view θf as illustrated in FIG. 6A, the position of the subject 20 is outside the angle of view of the camera unit 15. The subject 20 therefore does not appear in the image 21, and the subject information cannot be obtained from the second information obtainment unit 7. On the other hand, in the first information obtainment unit 4, the relative positional relationship between the image capturing apparatus 1 and the subject 20 can be obtained in the same manner as in the case illustrated in FIGS. 5A to 5C.

Accordingly, as described earlier, based on the information obtained by the first information obtainment unit 4, an angle θp is obtained through Formula (1), and the angle of view changing unit 30 changes the angle of view in the horizontal direction. This makes it possible to change the angle of view such that the subject 20 is located within the angle of view of the camera unit 15, and furthermore, in the proximate center of the image 21. In other words, when the first information obtainment unit 4 obtains the position information of the subject 20, and the position of the subject 20 obtained by the first information obtainment unit 4 is outside the angle of view of the camera unit 15, the angle of view changing unit 30 changes the angle of view in the horizontal direction. This makes it possible to perform the subject tracking shooting accurately even when the subject 20 is located outside the angle of view of the camera unit 15.

An example in which the position information of the subject 20 is obtained by the first information obtainment unit 4 in response the subject 20 moving in the horizontal direction, and subject tracking shooting is then performed, has been described thus far. However, it is conceivable that the accuracy of the position information of the subject obtained by the second information obtainment unit 7 will be higher than the accuracy of the position information of the subject obtained by the first information obtainment unit 4 due to the shooting conditions, the shooting environment, and the like. In this case, after changing the angle of view in the horizontal direction based on the position information of the subject 20 obtained by the first information obtainment unit 4, the position information of the subject 20 is obtained by the second information obtainment unit 7. The subject tracking shooting may then be carried out by further changing the angle of view in the horizontal direction based on the position information of the subject 20 obtained by the second information obtainment unit 7. In other words, after the angle of view changing unit 30 changes the angle of view of the camera unit 15 based on the first information, the angle of view of the camera unit 15 is changed based on the second information. In order to keep the subject 20 in the proximate center of the obtained image 21, after the subject 20 has moved to an approximate target position by changing the angle of view based on the information from the first information obtainment unit 4, the position information is obtained from the image 21 by the second information obtainment unit 7, after which the angle of view is changed. This makes it possible to perform highly accurate subject tracking shooting.

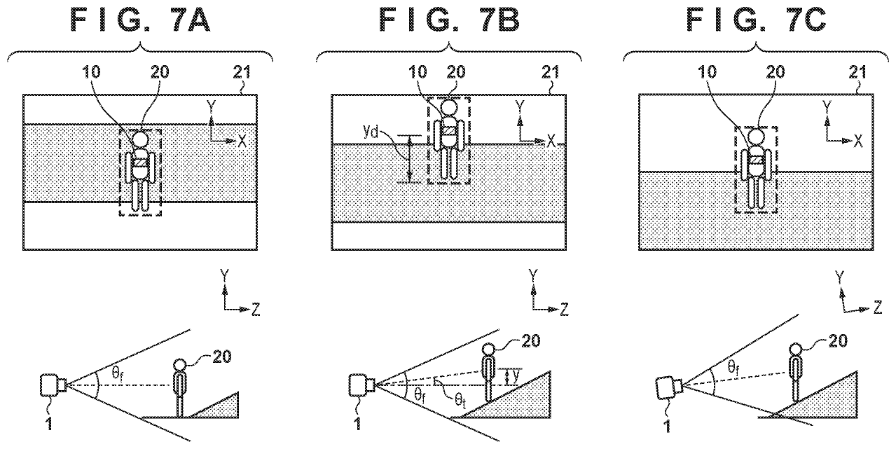

Next, subject tracking shooting performed when the subject 20 has moved in the vertical direction will be described with reference to FIGS. 7A to 7C. In FIGS. 7A to 7C, the diagrams on top are diagrams illustrating the image 21 obtained by the image sensor 3, and the diagrams on the bottom are diagrams illustrating the image capturing apparatus 1 and the subject 20 viewed from the horizontal direction (the X direction).

At the point in time of FIG. 7A, the subject 20 is located at the proximate center of the image 21. In contrast, in FIG. 7B, the subject 20 has moved by y in the vertical direction (the Y direction), and the subject 20 is located at a position shifted from the center of the image 21 by a shift amount yd. The shift amount yd at this time can be calculated by the second position computation unit 9 of the second information obtainment unit 7.

The image capturing apparatus 1 drives the tilt drive part 31 of the angle of view changing unit 30 and rotates the camera unit 15 in the vertical direction based on the drive commands generated by the drive command generation unit 16 such that the shift amount yd becomes 0. As a result, the angle of view can be changed such that the subject 20 is located at the proximate center of the image 21, as illustrated in FIG. 7C. Repeating the above-described processing makes it possible for the image capturing apparatus 1 to continuously keep the subject 20 in the proximate center of the image 21 even when the subject 20 moves in the vertical direction.

An example in which subject tracking shooting is performed using the information obtained by the second information obtainment unit 7 when the subject 20 has moved in the vertical direction has been described thus far. Although the movement of the subject 20 in the vertical direction can also be detected by the first information obtainment unit 4, it is known that with GPS, the detection accuracy in the vertical direction is lower than in the horizontal direction. Furthermore, depending on the detection method used by the first information obtainment unit 4, movement of the measurement unit 10 can only be detected in one direction, and there are situations where the movement of the subject 20 in the vertical direction cannot be detected. Accordingly, with respect to movement of the subject 20 in the vertical direction, the subject tracking shooting can be performed with high accuracy by the angle of view changing unit 30 changing the angle of view of the camera unit 15 based on the position information obtained by the second information obtainment unit 7.

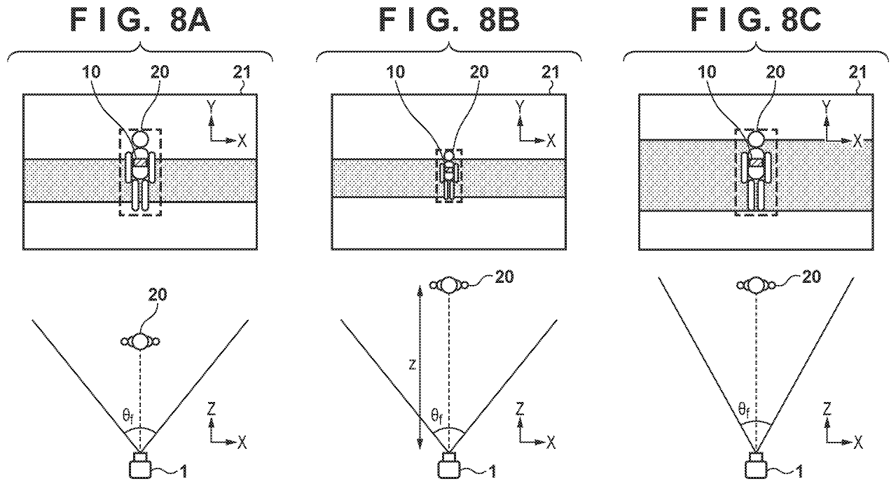

Next, subject tracking shooting performed when the subject 20 has moved in the optical axis direction will be described with reference to FIGS. 8A to 8C. In FIGS. 8A to 8C, the diagrams on top are diagrams illustrating the image 21 obtained by the image sensor 3, and the diagrams on the bottom are diagrams illustrating the image capturing apparatus 1 and the subject 20 viewed from the vertical direction (the Y direction).

At the point in time of FIG. 8A, the subject 20 has been shot at the shooting angle of view θf, and the subject 20 appears at a predetermined size in the proximate center of the image 21. In FIG. 8B, the subject 20 has moved in the optical axis direction such that the distance from the image capturing apparatus 1 has increased, and the size of the subject 20 in the image 21 has decreased as a result.

The image capturing apparatus 1 can obtain the relative positional relationship between the image capturing apparatus 1 and the subject 20 using the first information obtainment unit 4, and obtain a distance z from the image capturing apparatus 1 to the subject 20 based thereon. The image capturing apparatus 1 can change the magnitude of the angle of view to the shooting angle of view θf corresponding to the distance z, as illustrated in FIG. 8C, by controlling the driving of a plurality of optical elements constituting the lens 2. The size of the subject 20 in the image 21 is determined by the distance z and the shooting angle of view θf. When the size of the subject 20 has been set through operations made by the photographer, the image capturing apparatus 1 determines the appropriate shooting angle of view θf based on the distance z in accordance therewith, and changes the magnitude of the angle of view so as to keep the size of the subject 20 constant.

Additionally, although the lens 2 is illustrated separately from the angle of view changing unit 30 in FIG. 1, the angle of view changing unit 30 includes the lens 2 as a means for “changing the magnitude of the angle of view”. Repeating the above-described processing makes it possible for the image capturing apparatus 1 to continue shooting such that the subject 20 remains at a constant size in the image 21, even when the subject 20 moves in the optical axis direction.

An example in which the position information of the subject 20 is obtained by the first information obtainment unit 4 in response the subject 20 moving in the optical axis direction, and subject tracking shooting is then performed, has been described thus far. However, it is conceivable that, depending on the shooting conditions, the shooting environment, and the like, the size of the subject can be ascertained with greater accuracy using the size information of the subject 20 obtained by the second information obtainment unit 7 as opposed to the distance information of the subject 20 obtained by the first information obtainment unit 4. In this case, after changing the magnitude of the angle of view based on the information from the first information obtainment unit 4, the information on the size of the subject 20 is obtained by the second information obtainment unit 7. The subject tracking shooting may then be carried out by further changing the magnitude of the angle of view based on the information on the size of the subject obtained by the second information obtainment unit 7. In other words, after the angle of view changing unit 30 changes the angle of view of the camera unit 15 based on the first information, the angle of view of the camera unit 15 is changed based on the second information. In order to keep the size of the subject 20 in the obtained image 21 constant, after the subject 20 has roughly reached that size by changing the angle of view based on the information from the first information obtainment unit 4, the angle of view is changed based on the size information obtained by the second information obtainment unit 7 from the image 21. This makes it possible to perform even more accurate subject tracking shooting.

The size of the subject 20 in the image 21 decreases as the distance from the image capturing apparatus 1 to the subject 20 increases. It is necessary for the subject 20 to appear at at least a predetermined size in the image 21 in order for the second position computation unit 9 of the second information obtainment unit 7 to obtain the information on the position, size, and the like of the subject 20. As the size of the subject 20 in the image 21 decreases, problems arise in which the accuracy of detection decreases or the subject 20 cannot be detected. Accordingly, the first information obtainment unit 4 obtains the distance from the image capturing apparatus 1 to the subject 20, and if that distance exceeds a value set by the image capturing apparatus 1, the angle of view changing unit 30 changes the magnitude of the angle of view so as to increase the size of the subject 20 in the image 21.

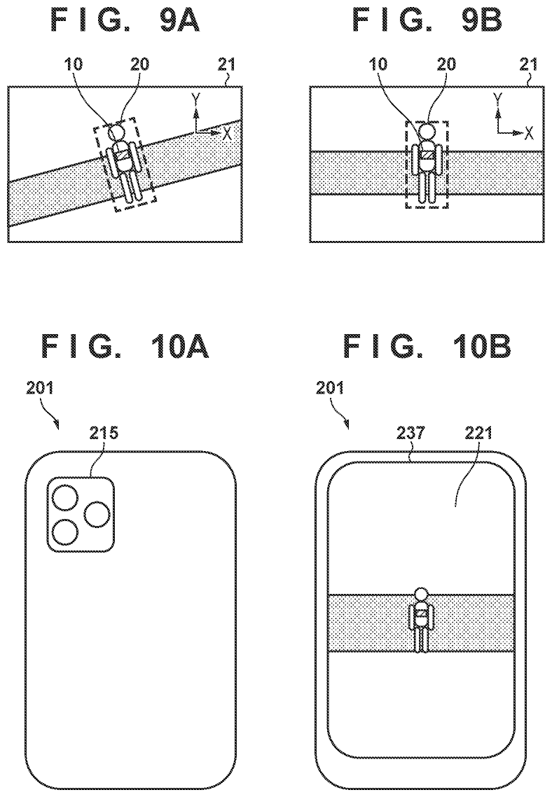

FIGS. 9A and 9B are diagrams illustrating changes in the angle of view when the camera unit 15 of the image capturing apparatus 1 has tilted relative to the vertical direction (and particularly, has rotated in the optical axis direction). In FIG. 9A, the subject 20 is tilted relative to the horizontal direction of the image 21. As illustrated in FIG. 1, the image capturing apparatus 1 is provided with the inertial sensor 22, and disposing the inertial sensor 22 in the camera unit 15 makes it possible to detect the tilt of the camera unit 15 as the attitude information. Note that the inertial sensor 22 is an attitude detection unit according to the present embodiment.

Specifically, a gyrosensor, an accelerometer, or the like is used for the inertial sensor 22, which detects the tilt of the camera unit 15 as the attitude information by detecting the rotation angle of the camera unit 15, the direction of gravity relative to the camera unit 15, and so on. Although a gyrosensor and an accelerometer have been given as examples of the inertial sensor 22, the configuration is not limited thereto, and various methods can be used to detect the attitude information of the camera unit 15. Additionally, although an example in which the inertial sensor 22 is provided in the camera unit 15 has been described, the attitude information of the camera unit 15 can be obtained based on the attitude information of the inertial sensor 22 and the driving states of the respective drive parts, from the tilt drive part 31 to the pan drive part 33, even in a configuration in which the inertial sensor 22 is provided in the grip part 36.

In FIG. 9A, the inertial sensor 22 can detect, as the attitude information, that the camera unit 15 is tilted about the rotational axis of the optical axis direction. The drive command generation unit 16 generates the drive commands based on the attitude information obtained by the inertial sensor 22, and by driving the roll drive part 32 based on the drive commands, the subject 20 can be shot in a state with no tilt, as illustrated in FIG. 9B. In other words, the angle of view changing unit 30 rotates the angle of view of the camera unit 15 about the optical axis based on the attitude information of the camera unit 15 obtained by the inertial sensor 22.

As described above, in the first embodiment, the angle of view changing unit 30 performs at least one of changing the angle of view to a predetermined direction or changing the magnitude of the angle of view based on the position information, distance information, and the like obtained by the first information obtainment unit 4 (the first information). Furthermore, based on the position information, size information, and the like obtained by the second information obtainment unit 7 (the second information), the angle of view is changed by changing the direction or magnitude in a different manner from the change in the angle of view made based on the first information. The subject tracking shooting is realized through this processing. More specifically, at least one of the angle of view in the horizontal direction or the magnitude of the angle of view is changed based on the first information, and the angle of view in the vertical direction, which is a different direction from the angle of view change made based on the first information, is changed based on the second information.

As described above, problems arise in which information cannot be obtained by the second information obtainment unit 7 due to the movement of the subject 20 in the horizontal direction, the subject 20 being positioned outside the angle of view, the movement of the subject 20 in the optical axis direction, the distance of the subject 20 being too great, and the like. In the present embodiment, the subject tracking shooting can be performed based on the information obtained by the first information obtainment unit 4, even in a situation where the subject 20 is positioned outside the angle of view and the distance from the image capturing apparatus 1 to the subject 20 is at least a predetermined distance.

With respect to movement of the subject 20 in the vertical direction, the accuracy of the position information obtained by the first information obtainment unit 4 is lower than for movement in the horizontal direction, and thus accurate tracking can be achieved by performing subject tracking shooting based on the information obtained by the second information obtainment unit 7.

Additionally, as described above, the subject 20 will not be detected by the second information obtainment unit 7 when the subject 20 is positioned outside the angle of view, the distance is at least a predetermined distance, or the like. However, there are cases where the subject 20 can be detected by the second information obtainment unit 7 by changing the angle of view in the horizontal direction, changing the magnitude of the angle of view, and the like based on the information from the first information obtainment unit 4. When the subject 20 has been detected by the second information obtainment unit 7, the angle of view can be changed in the vertical direction using the information from the second information obtainment unit 7. On the other hand, if, after changing the angle of view in the horizontal direction and the magnitude of the angle of view based on the information from the first information obtainment unit 4, the subject 20 cannot be detected by the second information obtainment unit 7, the subject 20 may be searched for and detected by the angle of view changing unit 30 changing the angle of view in the vertical direction.

Effects achieved by the first embodiment will be described hereinafter.

In the first embodiment, when the subject 20 has moved in the horizontal direction and the optical axis direction, subject tracking shooting is performed based on the information obtained by the first information obtainment unit 4. This makes it possible to perform subject tracking shooting based on the information obtained by the first information obtainment unit 4 even in a situation where the subject 20 is positioned outside the angle of view of the camera unit 15, the subject 20 is at at least a predetermined distance, or the like. With respect to movement of the subject 20 in the vertical direction, the accuracy of the position information obtained by the first information obtainment unit 4 is lower than for movement in the horizontal direction, and thus subject tracking shooting is performed based on the information obtained by the second information obtainment unit 7. This makes it possible to achieve highly-accurate tracking shooting.

As described above, in the first embodiment, the angle of view in the horizontal direction and the magnitude of the angle of view are changed based on the information obtained by the first information obtainment unit 4, and the angle of view in the vertical direction is changed based on the information obtained by the second information obtainment unit 7. This makes it possible to provide an image capturing apparatus capable of accurately tracking and shooting a subject inside or outside the angle of view of the image capturing apparatus while accurately detecting that subject.

### Second Embodiment

A second embodiment of the present invention will be described next.

The first embodiment described an example in which the angle of view changing unit 30 changes the angle of view of the camera unit 15 by changing the orientation of the camera unit 15.

The second embodiment differs from the first embodiment in that, in a configuration in which a part of an image 221 obtained by a camera unit 215 is cropped, the angle of view is changed by changing a cropping position and a cropping size. Parts that are the same as in the first embodiment will not be described, whereas parts that are different from those in the first embodiment will be described. Furthermore, in the following descriptions of the second embodiment, each constituent element will be indicated by a reference sign in which 200 has been added to the reference sign used in the descriptions of the first embodiment.

FIGS. 10A and 10B are diagrams illustrating the configuration of an image capturing apparatus 201 according to the second embodiment. FIG. 10A is a diagram illustrating a rear surface of the image capturing apparatus 201, and FIG. 10B is a diagram illustrating a front surface of the image capturing apparatus 201. The image capturing apparatus 201 includes the camera unit 215 on the rear surface. The camera unit 215 is configured including a lens and an image sensor, and light passing through the lens can be obtained as an image by the image sensor. A screen 237 capable of displaying the image 221 obtained by the image sensor is provided on the front surface of the image capturing apparatus 201.

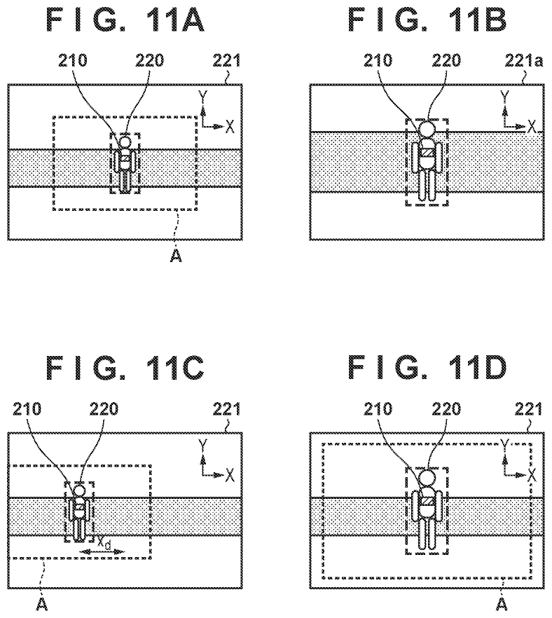

A method for changing the angle of view according to the second embodiment will be described with reference to FIGS. 11A to 11D. FIG. 11A illustrates the image 221 obtained by the image sensor. FIG. 11B illustrates a cropped image 221a obtained by cropping a part of the image 221, indicated by a cropping region A. By cropping using cropping region A, the cropped image 221a becomes an image in which part of the image 221 has been enlarged.

As illustrated in FIG. 11C, if a subject 220 has moved by xd in the horizontal direction, moving the position of the cropping region A by xd makes it possible to obtain an image in which the subject 220 is located in the proximate center of the cropped image 221a, as illustrated in FIG. 11B. If the subject 220 has moved in the vertical direction, the angle of view is changed by moving the cropping region A in the vertical direction, in the same manner as when the subject 220 has moved in the horizontal direction. An image in which the subject 220 is located in the proximate center of the image 221a can then be obtained.

Furthermore, as illustrated in FIG. 11D, if the size of the subject 220 in the image 221 has changed as a result of the subject 220 moving in the optical axis direction, the size of the cropping region A is changed. Through this, shooting can be performed while keeping the size of the subject 220 in the cropped image 221a constant. In other words, the angle of view changing unit 30 (230) changes the angle of view by changing the position or size of the cropping region A when obtaining the cropped image 221a by cropping a part of the image 221. The position, size, or both of the cropping region A in the horizontal direction are changed based on the information obtained by the first information obtainment unit 4 (204) as the subject 220 moves. The position of the cropping region A in the vertical direction is then changed based on the information obtained by the second information obtainment unit 7 (207). This makes it possible to provide an image capturing apparatus 201 capable of tracking and shooting the subject 220 while accurately detecting the subject 220 inside or outside the angle of view of the image capturing apparatus 201.

Although the angle of view changing unit 30 changed the angle of view of the camera unit 15 by mechanically driving the camera unit 15 in the first embodiment, in the second embodiment, the angle of view is changed by changing the position and size of the cropping region A in the image 221. This eliminates the need for a configuration for mechanically driving the camera unit 15, and thus the second embodiment has an advantage that the size and the cost of the image capturing apparatus 201 can be reduced as compared with the first embodiment.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-203529, filed Dec. 20, 2022, which is hereby incorporated by reference herein in its entirety.

What is claimed is:

1. An image capturing apparatus comprising:
an image capturing device that captures an image of a subject; and
at least one processor or circuit configured to function as:
a first obtainment unit that, using a first method, obtains first information that is information pertaining to a position of the subject;
a second obtainment unit that, using a second method different from the first method, obtains second information that is information pertaining to the position of the subject; and
a changing unit that changes an angle of view of the image capturing device,
wherein the changing unit performs at least one of changing the angle of view in a first direction or changing a magnitude of the angle of view, based on the first information, and performs at least one of changing the angle of view in a second direction different from the first direction or changing a magnitude of the angle of view, based on the second information.

2. The image capturing apparatus according to claim 1,
wherein the first obtainment unit obtains the first information by communicating with a measurement device with which the subject is provided.

3. The image capturing apparatus according to claim 1,
wherein the first obtainment unit obtains the first information using a global positioning system (GPS).

4. The image capturing apparatus according to claim 1,
wherein the second obtainment unit obtains the second information from an image captured by the image capturing device.

5. The image capturing apparatus according to claim 1,
wherein the first direction is a horizontal direction.

6. The image capturing apparatus according to claim 1,
wherein the second direction is a vertical direction.

7. The image capturing apparatus according to claim 1,
wherein the changing unit drives a device that changes the angle of view of the image capturing device mechanically.

8. The image capturing apparatus according to claim 1,
wherein the changing unit changes the angle of view of the image capturing device by cropping a part of the image.

9. The image capturing apparatus according to claim 1,
wherein the changing unit further changes the angle of view based on the second information after changing the angle of view based on the first information.

10. The image capturing apparatus according to claim 1,
wherein when the position of the subject based on the first information is a position outside the angle of view of the image capturing device, the changing unit changes the angle of view of the image capturing device such that the subject is at a position within the angle of view of the image capturing device.

11. The image capturing apparatus according to claim 1,
wherein when a distance from the image capturing device to the subject based on the first information exceeds a predetermined distance, the changing unit changes the magnitude of the angle of view.

12. The image capturing apparatus according to claim 1, further comprising:
an attitude detection device that detects an attitude of the image capturing device,
wherein the changing unit changes the angle of view based on the attitude detected by the attitude detection device.

13. A method of controlling an image capturing apparatus, the image capturing apparatus including an image capturing device that captures an image of a subject, and the method comprising:
obtaining, using a first method, first information that is information pertaining to a position of the subject;
obtaining, using a second method different from the first method, second information that is information pertaining to the position of the subject; and
changing an angle of view of the image capturing device,
wherein the changing includes performing at least one of changing the angle of view in a first direction or changing a magnitude of the angle of view, based on the first information, and performing at least one of changing the angle of view in a second direction different from the first direction or changing a magnitude of the angle of view, based on the second information.

14. A non-transitory computer-readable storage medium storing a program for causing a computer to execute each of steps of a method of controlling an image capturing apparatus, the image capturing apparatus including an image capturing device that captures an image of a subject, and the method comprising:
obtaining, using a first method, first information that is information pertaining to a position of the subject;
obtaining, using a second method different from the first method, second information that is information pertaining to the position of the subject; and
changing an angle of view of the image capturing device,
wherein the changing includes performing at least one of changing the angle of view in a first direction or changing a magnitude of the angle of view, based on the first information, and performing at least one of changing the angle of view in a second direction different from the first direction or changing a magnitude of the angle of view, based on the second information.
